(19) United States
(12) Patent Application Publication
(10) Pub. No.: US 2009/0099332 A1
(43) Pub. Date: Apr. 16, 2009

(54) FORMALDEHYDE-FREE, OH-FUNCTIONAL, CARBONYL- AND RING-HYDROGENATED KETONE-ALDEHYDE RESINS BASED ON ALKYL ARYL KETONES AND FORMALDEHYDE AND A PROCESS FOR PREPARING THEM

(75) Inventors: Patrick Glockner, Haltern am See (DE); Christian Lettmann, Coesfeld (DE); Michael Ewald, Marl (DE); Andreas Wenning, Nottuln (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Evonik Degussa GMBH, Essen (DE)

(21) Appl. No.: 12/301,619

(22) PCT Filed: May 15, 2007
(86) PCT No.: PCT/EP07/54690

§ 371 Date: Nov. 20, 2008

(30) Foreign Application Priority Data
Jun. 9, 2006 (DE) 102006026760.5

(51) Int. Cl. C08G 6/02

(52) U.S. Cl. 528/223; 528/227; 528/225

(57) ABSTRACT

The invention relates to formaldehyde-free, OH-functional, carbonyl- and ring-hydrogenated ketone-aldehyde resins based on alkyl aryl ketones and formaldehyde and having a low fraction of crystallisable compounds, low viscosity, very low colour number, broad solubility, and very high heat stability and light stability, and also to a process for preparing them.

The invention relates to formaldehyde-free, OH-functional, carbonyl- and ring-hydrogenated ketone-aldehyde resins based on alkyl aryl ketones and formaldehyde and having a low fraction of crystallisable compounds, low viscosity, very low colour number, broad solubility, and very high heat stability and light stability, and also to a process for preparing them.

It is known that ketones or mixtures of ketones and aldehydes can be reacted in the presence of basic catalysts or acids to form resinous products. For instance, mixtures of cyclohexanol and methylcyclohexanone can be used to prepare resins (Ullmann Vol. 12, p. 551). The reaction of ketones and aldehydes usually results in hard resins, which are often employed in the coatings industry.

Industrially significant ketone-aldehyde resins are nowadays usually prepared using formaldehyde.

Ketone-formaldehyde resins are well established. Preparation processes are described for example in DE 33 24 287, U.S. Pat. No. 2,540,885, U.S. Pat. No. 2,540,886, DE 11 55 909, DD 12 433, DE 13 00 256, and DE 12 56 898.

The preparation normally involves reacting ketones with formaldehyde in the presence of bases.

Ketone-aldehyde resins are employed in coating materials as, for example, film-forming addition components, in order to enhance certain properties such as rate of initial dry, gloss, hardness or scratch resistance. On account of their relatively low molecular weight typical ketone-aldehyde resins possess a low melt viscosity and solution viscosity and are therefore used as film-forming functional fillers, among other things, in coating materials.

As a result, for example, of exposure to sunlight, for example, the carbonyl groups of the ketone-aldehyde resins are subject to conventional degradation reactions, such as those of Norrish type I or II, for example [Laue, Plagens, Namen- und Schlagwort-Reaktionen, Teubner Studienbücher, Stuttgart, 1995].

It is therefore not possible to use unmodified ketone-aldehyde resins or ketone resins for high-quality applications in the exterior sector, for example, where high resistance properties, particularly in respect of weathering and heat, are required. These disadvantages can be remedied by hydrogenating the carbonyl groups. The conversion of the carbonyl groups into secondary alcohols by hydrogenation of ketone-aldehyde resins has been practiced for a long time (DE 826 974, DE 870 022, JP 11012338, U.S. Pat. No. 6,222,009).

The preparation of carbonyl-hydrogenated and ring-hydrogenated ketone-aldehyde resins on the basis of alkyl aryl ketones is not described.

Industrially significant ketone-aldehyde resins are obtained on the basis of formaldehyde and acetophenone (Stoye, Freitag, Lackharze. Chemie, Eigenschaften und Anwendungen. Hanser Fachbuch (July 1996)).

Besides the presence of the carbonyl groups the aromatic structural elements restrict a high heat stability and light stability. Products of this kind, therefore, in spite of their very good general profile of properties, are not suitable for use in weathering-stable coating materials, for example.

The preparation of carbonyl-hydrogenated and ring-hydrogenated ketone-aldehyde resins on the basis of ketones which contain such aromatic groups is described in DE 33 34 631. The processes set out therein lead to products which in comparison to the starting products possess improved properties in terms of colour, heat stability, and light stability. Moreover, the solubility profile of the starting resins is altered. From a present-day standpoint, the performance of these products is no longer adequate, in spite of their improvement.

As demonstrated by comprehensive findings of our own, furthermore, a feature common to the hydrogenated products described therein is a relatively high free formaldehyde content. The hydrogenation processes described by the prior art do reduce the free formaldehyde fraction as compared with that of unhydrogenated ketone-formaldehyde resins, but there remain significant amounts of free formaldehyde in the hydrogenation products. Longer hydrogenation times can lead to a further-reduced formaldehyde content, but may also have deleterious consequences for other resin properties, such as colour, melting ranges, OH numbers, etc., and because of the reduced productivity is not a feasible solution. Moreover, our own findings demonstrate that the level of crystallisable compounds and the colour numbers are high.

Formaldehyde may give rise to physiological damage. At the present time, however, no precise classification has been undertaken. The International Agency for Research on Cancer (IARC), and institution of the World Health Organization (WHO), recently found, on the basis of a study, that formaldehyde induces nasopharyngeal cancer, which occurs very rarely on a spontaneous basis, in humans.

Although the IARC evaluation is purely scientific and as yet does not give rise to any direct legal consequences, the provision of formaldehyde-free products is nevertheless vital in the spirit of “sustainable development” and “responsible handling of chemicals”. Moreover, it is assumed that in the medium term there will only be formaldehyde-free products on the market.

A method of lowering the formaldehyde content of nonhydrogenated acetone-formaldehyde resins without reducing the carbonyl groups is described in U.S. Pat. No. 5,247,006. There a free formaldehyde content of below 0.4% is reached, although by present-day yardsticks this is significantly too high. Moreover, this leaves aromatic structural elements and carbonyl groups unhydrogenated.

Ketone-aldehyde resins have long been used to increase the nonvolatiles content of coating materials. Under the compulsion of new directives such as, for example, EU Council Directive 1999/13/EC on the limiting of emissions of volatile organic compounds it is necessary to achieve further improvements in these properties.

During the synthesis of ketone-formaldehyde resins it is possible for crystallisable compounds to be formed, which are primarily cyclic oligomers. If the carbonyl groups of these secondary components are hydrogenated, the resulting products tend to crystallize in solution (formula I), which in coating materials can lead to processing disadvantages.

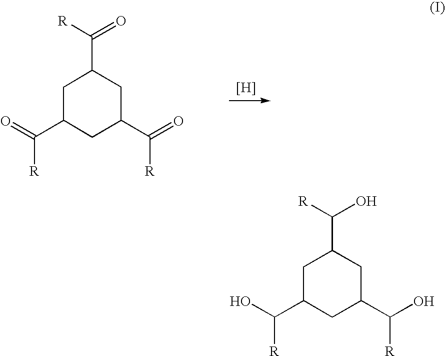

It was an object of the present invention, therefore, to find carbonyl-hydrogenated and ring-hydrogenated ketone-aldehyde resins based on alkyl aryl ketones and formaldehyde that are free from free formaldehyde and that owing to the presence of OH groups are amiable to crosslinking using, for example, polyisocyanates or melamine-formaldehyde resins. The fraction of crystallisable compounds ought to be as low as possible. Furthermore, the properties of the resins in terms of solution viscosity in tandem with high melting range and colour ought to be improved further, and there ought to be a very high heat stability and light stability.

It was a further object of the present invention to develop a process for preparing such products.

Surprisingly it has been possible to achieve this object in accordance with the claims, by reacting specially prepared ketone-aldehyde resins based on alkyl aryl ketones and formaldehyde with hydrogen in the presence of catalysts which on the one hand catalyze the selective hydrogenation of the carbonyl groups and the aromatic structural elements of the resins and on the other hand reduce the content of free formaldehyde.

The ketone-aldehyde resins carbonyl-hydrogenated and ring-hydrogenated in accordance with the invention possess outstanding light stability and heat stability and a very low colour. The products possess a low fraction of carbonyl groups and aromatic structural elements and of crystallisable compounds, and are virtually free from formaldehyde. The hydroxyl number can be adjusted. Despite the high melting range, and in contrast to the prior art, the solution viscosity is low and can be realized through the use of tailored starting resins for the hydrogenation that possess a particularly narrow molecular weight distribution.

The invention provides OH-functional, carbonyl- and ring-hydrogenated ketone-aldehyde resins based on alkyl aryl ketones and formaldehyde, having a hydroxyl number of at least 75 mg KOH/g, having a free formaldehyde content of less than 3 ppm, and containing substantially the structural elements of formula II

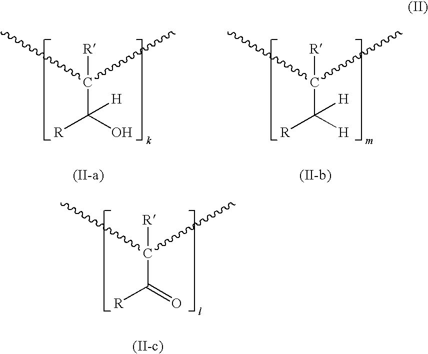

where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),

### R′ is H, CH₂OH,

k is 1 to 10, preferably 1 to 8, more preferably 1 to 5,
m is 2 to 12, preferably 2 to 9, more preferably 2 to 8, and
l is 0 to 0.35, preferably 0 to 0.30,
the sum of k+l+m being from 3 to 24, preferably from 5 to 14,
the ratio of m/k being >1.0, preferably >1.5,
and it being possible for the three structural elements to be distributed alternatingly or randomly, and the structural elements being linked linearly via CH₂ groups and/or with branching via CH groups.

The invention provides OH-functional, carbonyl- and ring-hydrogenated ketone-aldehyde resins based on alkyl aryl ketones and formaldehyde, having a hydroxyl number of at least 75 mg KOH/g, having a free formaldehyde content of less than 3 ppm, and containing substantially the structural elements of formula II

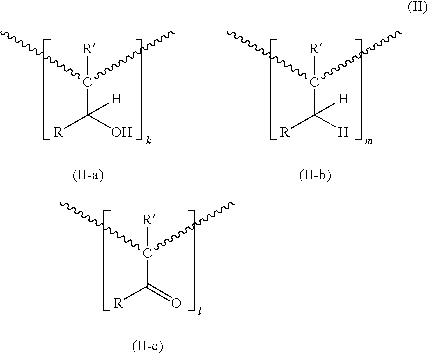

where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),

### R′ is H, CH₂OH,

k is 1 to 10, preferably 1 to 8, more preferably 1 to 5,
m is 2 to 12, preferably 2 to 9, more preferably 2 to 8, and
l is 0 to 0.35, preferably 0 to 0.30,
the sum of k+l+m being from 3 to 24, preferably from 5 to 14,
the ratio of m/k being >1.0, preferably >1.5,
and it being possible for the three structural elements to be distributed alternatingly or randomly, and the structural elements being linked linearly via CH₂ groups and/or with branching via CH groups,
obtained by
A) preparing the base resin by condensing at least one ketone with at least one aldehyde in the presence of at least one basic catalyst and, if desired, of at least one phase transfer catalyst, solventlessly or using a water-miscible organic solvent,
   and subsequently
B) subjecting the carbonyl groups and the aromatic groups of the ketone-aldehyde resins (A) to continuous, semibatchwise or batchwise hydrogenation in the melt or in solution in a suitable solvent with hydrogen in the presence of a catalyst at pressures from 150 to 350 bar, preferably from 175 to 300 bar, more preferably from 200 to 300 bar, and at temperatures from 150 to 250° C., preferably from 150 to 225° C.

The invention preferredly provides carbonyl-hydrogenated and ring-hydrogenated ketone-aldehyde resins, based on alkyl aryl ketones and formaldehyde, these resins having the following properties:
the free formaldehyde content is below 3 ppm, preferably below 2.5 ppm, more preferably below 2.0 ppm,
the amount of crystallisable compounds is below 3%, preferably below 2%, more preferably below 1%, by weight,
the carbonyl number is from 0 to 20 mg KOH/g, preferably from 0 to 18 mg KOH/g, more preferably from 0 to 15 mg KOH/g,
the hydroxyl number is from 75 to 350 mg KOH/g, preferably from 75 to 200 mg KOH/g, more preferably from 75 to 180 mg KOH/g,
the proportion of aromatic structural elements is below 10, preferably below 5 mg alkyl aryl ketone/g (based on alkyl aryl ketone),
the Gardner colour number (50% by weight in ethyl acetate) is below 1.5, preferably below 1.0, more preferably below 0.75,
the Gardner colour number (50% by weight in ethyl acetate) after thermal exposure of the resin (24 h, 150° C.) is below 2.0, preferably below 1.5, more preferably below 1.0,
the polydispersity (Mw/Mn) of the resins is from 1.35 to 1.7, more preferably from 1.4 to 1.6,
the solution viscosity, 40% strength by weight in phenoxyethanol, is from 1000 to 15 000 mPa·s, more preferably from 3000 to 10 000 mPa·s,
the melting point/range is from 50 to 150° C., preferably from 60 to 140° C., more preferably from 75 to 130° C.,
the amount of nonvolatile constituents after heating at 150° C. for 24 h is more than 97.0% by weight, preferably more than 97.5% by weight, and
a solubility in n-hexane, in white spirit and in ethanol at 10% and 50% strength by weight.

The properties of the carbonyl- and ring-hydrogenated ketone-aldehyde resins of the invention may adopt all possible variations within the abovementioned values. As an example, a resin having a hydroxyl number of 350 mg KOH/g—upper limit—and a free formaldehyde content of below 2 ppm—lower limit—etc.

The invention also provides a process for preparing the OH-functional carbonyl-hydrogenated and ring-hydrogenated ketone-aldehyde resins based on alkyl aryl ketones and formaldehyde, with a hydroxyl number of at least 75 mg KOH/g, with a free formaldehyde content of less than 3 ppm, which substantially contain the structural elements of formula II, said process comprising
A) preparing the base resins by condensing at least one ketone with at least one aldehyde in the presence of at least one basic catalyst and, if desired, of at least one phase transfer catalyst, solventlessly or using a water-miscible organic solvent,
   and subsequently
B) subjecting the carbonyl groups and the aromatic groups of the ketone-aldehyde resins (A) to continuous, semibatchwise or batchwise hydrogenation in the melt or in solution in a suitable solvent with hydrogen in the presence of a catalyst at pressures from 150 to 350 bar, preferably from 175 to 300 bar, more preferably from 200 to 300 bar, and at temperatures from 150 to 250° C., preferably from 150 to 225° C.

As a result of the process of the invention it is possible sharply to reduce the amount of physiologically harmful formaldehyde. Formaldehyde-free means that the carbonyl-hydrogenated ketone-aldehyde resins of the invention possess a free formaldehyde content of less than 3 ppm, preferably less than 2.5 ppm, more preferably less than 2.0 ppm.

The process of the invention very substantially prevents the formation of crystallisable compounds. The amount of crystallisable compounds in the products of the invention is below 3%, preferably below 2%, more preferably below 1%, by weight. As a result it is possible always to prepare clear solutions of the products of the invention. This is particularly important with a view to preventing clogging of, for example, spraygun nozzles or ballpoint pen reservoirs.

It has been found that a low colour number and a high thermal stability are the result of a low carbonyl number (I<0.35 from II-c). The carbonyl number of the products of the invention is from 0 to 20 mg KOH/g, preferably from 0 to 18 mg KOH/g, more preferably from 0 to 15 mg KOH/g, so that the Gardner colour number (50% by weight in ethyl acetate) of the products of the invention is below 1.5, preferably below 1.0, more preferably below 0.75, and the Gardner colour number (50% by weight in ethyl acetate) after thermal exposure of the products of the invention (24 h, 150° C.) is below 2.0, preferably below 1.5, more preferably below 1.0.

Solubility should as far as possible be universal, since this ensures compatibility with typical film-forming binders and hence means that the range of usefulness of the products of the invention in paint and printing-ink applications is not limited. The products of the invention are soluble at 10% and 50% strength by weight in typical organic solvents such as, for example, alcohols (ethanol, n- and isobutanol), ketones (e.g. butanone), esters (e.g. ethyl acetate, butyl acetate), aromatics (e.g. xylene), and aliphatic solvents (e.g. white spirits or n-hexane). In addition they are soluble in monomers which are used in UV-curable paints and printing inks, such as monofunctional and/or higher functional acrylate monomers, for example.

This universal solubility profile can be brought about through the choice of the ratio between k, l, and m in formula II (k=1 to 10, preferably 1 to 8, more preferably 1 to 5, m=2 to 12, preferably 2 to 9, more preferably 2 to 8, and l=0 to 0.35, preferably 0 to 0.30, with m/k>1.0) and also by minimising the proportion of aromatic structures in the resin.

Based on the respective alkyl aryl ketone (acetophenone, for example), the proportion of aromatic structural elements is below 10, preferably below 5 mg alkyl aryl ketone/g resin.

A very low solution viscosity is desirable so that the fraction of organic solvents, needed, among other things, in order e.g. to lower the solution viscosity of a coating material into the desired processing range, is as low as possible, on the basis of economic viability and environmental aspects. The solution viscosity of the products of the invention, 40% strength by weight in phenoxyethanol, is from 1000 to 15 000 mPa·s, more preferably from 3000 to 10 000 mPa·s.

For a given molecular weight (Mn), the greater the nonuniformity of the dissolved polymer (high polydispersity) the higher the solution viscosity. The resins of the invention possess low polydispersities (Mw/Mn) of from 1.35 to 1.7, more preferably from 1.4 to 1.6.

A very high melting range on the part of the resins of the invention is desirable so that, for example, the rate of initial dry of the coating materials, and the hardness of the coatings, are as high as possible.

One way of obtaining a high melting point/range is via a high molecular weight (sum of k+l+m in formula II). The higher molecular weight, however, the higher the solution viscosity as well. Consequently it was desirable to raise the melting point/range without increasing the molecular weight. It proved possible to achieve this by selecting k in formula II preferably to be as high as possible. However, since a high k in formula II is detrimental to the solubility properties in apolar solvents, the ratio m/k is chosen so as to be always more than 1.0.

The value of k is 1 to 10, preferably 1 to 8, particularly preferably 1 to 5, and the value of m is 2 to 12, preferably 2 to 9, particularly preferably 2 to 8. The resins of the invention possess melting points/ranges from 50 to 150° C., preferably from 60 to 140° C., more preferably from 75 to 130° C.

The value of k in formula II must, however, be chosen to be sufficiently high that the resins of the invention are soluble in polar solvents such as alcohols, for example. The value of k is correlated with the hydroxyl number. The higher the hydroxyl number (high k), the higher the melting point/range and the better the solubility in polar solvents. Ideally the hydroxyl number is situated between 75 and 350 mg KOH/g, preferably between 75 and 200 mg KOH/g, more preferably between 75 and 180 mg KOH/g.

The values of k, l, and m and also the sum of the value may take on whole numbers, 2 for example, or else values in between, such as 2.4, for example.

### Components for Preparing the Base Resins A)

### Ketones and Aldehydes

Suitable ketones for preparing the carbonyl-hydrogenated and ring-hydrogenated ketone-aldehyde resins based on alkyl aryl ketones and formaldehyde include all ketones having alkyl aromatic structural elements, in particular all aromatic α-methyl ketones such as acetophenone, for example, acetophenone derivatives such as hydroxyacetophenone, for example, alkyl-substituted acetophenone derivatives having 1 to 8 carbon atoms on the phenyl ring, methoxyacetophenone, alone or in mixtures. These ketones are present at 70 to 100 mol %, based on the ketone component, in the resins of the invention.

Preference is given to carbonyl- and ring-hydrogenated ketone aldehyde resins based on acetophenone.

In addition it is possible to use further CH-acidic ketones to a minor extent in a mixture with the abovementioned ketones, at up to 30 mol %, preferably up to 15 mol %, based on the ketone component, such as acetone, methyl ethyl ketone, 3,3-dimethyl-butanone, methyl isobutyl ketone, propiophenone, heptan-2-one, pentan-3-one, cyclopentanone, cyclododecanone, mixtures of 2,2,4- and 2,4,4-trimethyl-cyclopentanone, cycloheptanone and cyclooctanone, cyclohexanone and all alkyl-substituted cyclohexanones having one or more alkyl radicals with a total of 1 to 8 carbon atoms, for example, individually or in a mixture. Examples that may be given of alkyl-substituted cyclohexanones include 4-tert-amylcyclohexanone, 2-sec-butyl-cyclohexanone, 2-tert-butylcyclohexanone, 4-tert-butylcyclohexanone, 2-methyl-cyclohexanone, and 3,3,5-trimethylcyclohexanone. Preference as further CH-acidic ketones is given to cyclohexanone, methyl ethyl ketone, 2-tert-butylcyclohexanone, 4-tert-butylcyclohexanone, 3,3,5-trimethylcyclohexanone, 3,3-dimethylbutanone, and methyl isobutyl ketone.

In addition to formaldehyde, additional suitable aldehyde components of the carbonyl-hydrogenated ketone-aldehyde resins based on formaldehyde include in principle, unbranched or branched aldehydes, such as, for example, acetaldehyde, n-butyraldehyde and/or isobutyraldehyde, valeraldehyde, and dodecanal, for example. Generally speaking it is possible to use all of the aldehydes said to be suitable in the literature for ketone resin syntheses. It is preferred, however, to use formaldehyde alone. The further aldehydes can be employed in fractions from 0 to 75 mol %, preferably from 0 to 50 mol %, more preferably from 0 to 25 mol %, based on the aldehyde component. Aromatic aldehydes, such as benzaldehyde, may likewise be present at up to 10 mol % in a mixture with formaldehyde.

The required formaldehyde is typically used as an aqueous or alcoholic (e.g., methanol or butanol) solution with a strength of approximately from 20% to 40% by weight. Other use forms of formaldehyde are formaldehyde donor compounds such as para-formaldehyde and/or trioxane, for example.

Especially preferred for use as starting compounds for the carbonyl-hydrogenated resins are acetophenone, and if appropriate CH acid ketones selected from cyclohexanone, methyl ethyl ketone, 2-tert-butylcyclohexanone, 4-tert-butylcyclohexanone, 3,3,5-trimethylcyclohexanone, 3,3-dimethylbutanone, and methyl isobutyl ketone, alone or in a mixture, and formaldehyde. It is also possible in this context to use mixtures of different ketone-aldehyde resins.

The molar ratio of the ketone to the aldehyde component is from 1:0.25 to 1:15, preferably from 1:0.9 to 1:5, and more preferably from 1:0.95 to 1:4.

### Process for Preparing the Carbonyl-Containing Base Resins A)

Vastly important properties, such as molecular weight and molecular-weight distribution, amount of crystallisable compounds or solution viscosities, of the carbonyl- and ring-hydrogenated products of the invention correlate directly with the controlled synthesis of the carbonyl-containing base resins A). It was surprising, moreover, that colour numbers and the amount of free formaldehyde in the carbonyl- and ring-hydrogenated products of the invention are critically influenced by the chosen reaction conditions when preparing the base resins A).

For preparing the carbonyl-containing base resins A) the respective ketone or a mixture of different ketones is reacted with formaldehyde or a mixture of formaldehyde and additional aldehydes in the presence of at least one basic catalyst. Especially when using aqueous formaldehyde solution and ketones of limited water-solubility it is possible with advantage to use water-miscible organic solvents. On account of the improved phase mixing associated with this as well as with other factors, the conversion in the reaction is in this case more rapid and more complete. Moreover it may be possible in addition, if desired, to use at least one phase transfer catalyst, permitting a reduction in the amount of alkali metal compound, for example. After the end of the reaction the aqueous phase is separated from the resin phase. The crude product is washed with acidic water until a melt sample of the resin appears clear. The resin is then dried by distillation.

The reaction for preparing the base resins from ketone and aldehyde is carried out in a basic medium. Generally speaking it is possible to use all of the basic catalysts said to be suitable in the literature for ketone resin syntheses, such as alkali metal compounds, for example. Preference is given to hydroxides, such as of the cations NH₄, NR₄, with R═H, alkyl and/or benzyl, Li, Na, for example.

The reaction for preparing the base resins from ketone and aldehyde can be carried out using an auxiliary solvent. Alcohols such as methanol or ethanol, for example, have proven suitable. It is also possible to use water-soluble ketones as auxiliary solvents, which in that case are incorporated into the resin by reaction as well.

In order to purify the base resins A) it is necessary to remove the basic catalyst used from the resin A). This can be done easily by washing the resin with water using acids for neutralization. In general all acids, such as all organic and/or inorganic acids, but also ion exchangers, are suitable for the neutralization. Preference is given however to organic acids having 1 to 6 carbon atoms, more preference to organic acids having 1 to 4 carbon atoms.

In the polycondensation mixture for preparing the base resins from ketone and aldehyde it is additionally possible, optionally, to use phase transfer catalysts.

When using a phase transfer catalyst use is made of 0.01% to 15% by weight, based on the ketone, of a phase transfer catalyst of the general formula (A)

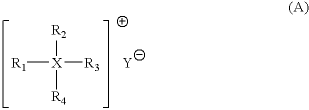

where
X is a nitrogen or phosphorus atom,
R₁, R₂, R₃, and R₄ can be identical or different and are each an alkyl radical having 1 to 22 carbon atoms in the carbon chain and/or a phenyl and/or benzyl radical,
   and
Y is the anion of an (in)organic acid or a hydroxide ion.

For the case of quaternary ammonium salts preference is given to alkyl radicals (R₁₋₄) having 1 to 22 carbon atoms, especially those having 1 to 12 carbon atoms, in the carbon chain and/or to phenyl and/or benzyl radicals and/or mixtures of both. Suitable anions include those of strong (in)organic acids such as, for example, Cl⁻, Br⁻, I⁻, and also hydroxides, methoxides or acetates. Examples of quaternary ammonium salts are cetyldimethylbenzylammonium chloride, tributylbenzylammonium chloride, trimethyl-benzylammonium chloride, trimethylbenzylammonium iodide, triethylbenzylammonium chloride or triethylbenzylammonium iodide, tetramethylammonium chloride, tetraethyl-ammonium chloride, and tetrabutylammonium chloride. Preference is given to using benzyltributylammonium chloride, cetyldimethylbenzylammonium chloride and/or triethyl benzylammonium chloride.

For quaternary phosphonium salts preference is given for R₁₋₄ to alkyl radicals having 1 to 22 carbon atoms and/or phenyl radicals and/or benzyl radicals. Suitable anions include those of strong (in)organic acids such as, for example, Cl⁻, Br⁻, and I⁻, and also hydroxides, methoxides or acetates.

Suitable quaternary phosphonium salts include triphenylbenzylphosphonium chloride or triphenylbenzylphosphonium iodide, for example. It is, however, also possible to use mixtures.

The phase transfer catalyst present if desired is used in amounts from 0.01% to 15%, preferably from 0.1% to 10.0%, and in particular in amounts from 0.1% to 5.0%, by weight, based on the ketone employed, in the polycondensation mixture.

### PARTICULARLY PREFERRED EMBODIMENT

In one particularly preferred embodiment the carbonyl-containing and aromatic-containing base resin A) is prepared first of all. For this purpose 10 mol of ketone (a ketone or a mixture of different ketones) are introduced initially in a 50% to 90% strength by weight methanolic solution, together with 0 to 5% by weight of a phase transfer catalyst and 1 to 5 mol of an aqueous formaldehyde solution, and this initial charge is homogenized with stirring. Then 0.1 to 5 mol of an aqueous sodium hydroxide solution are added with stirring. This is followed at 70 to 115° C., again with stirring, by the addition of 4 to 10 mol of an aqueous formaldehyde solution over 30 to 120 min. The stirrer is switched off after a further 0.5 to 5 h of stirring at reflux temperature. Optionally it is possible, after about a third of the operating time, to add a further 0.1 to 1 mol of an aqueous formaldehyde solution. The aqueous phase is separated from the resin phase. The crude product is washed with water using an organic acid until a melt sample of the resin appears clear. Then the resin is dried by distillation.

### Process for Preparing the Resins According to the Invention According to Process Step B)

The resins formed from ketone and aldehyde are hydrogenated with hydrogen in the presence of a catalyst. The carbonyl groups of the ketone-aldehyde resin are converted in this hydrogenation into a secondary hydroxyl group. Depending on reaction conditions, some of the hydroxyl groups may be eliminated, resulting in methylene groups. The reaction conditions are selected such that the fraction of unreduced carbonyl groups is low. Moreover, through the choice of the hydrogenating conditions, at the same time the aromatic structural elements are converted, completely as far as possible, into cycloaliphatic units.

The following simplified scheme serves for illustration:

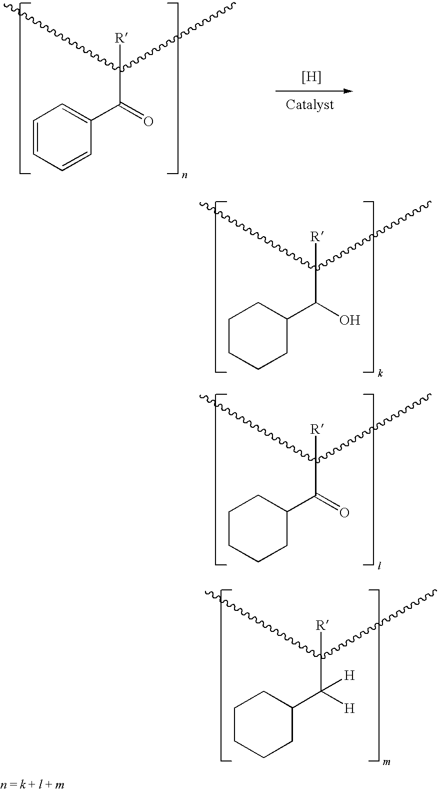

Catalysts which can be used include in principle all compounds which catalyze the hydrogenation of carbonyl groups and aromatic groups and also the hydrogenation of free formaldehyde to methanol with hydrogen. Both homogeneous and heterogeneous catalysts can be used, particular preference being given to heterogeneous catalysts.

For the purpose of obtaining the formaldehyde-free products of the invention, metal catalysts selected from nickel, copper, copper-chromium, palladium, platinum, ruthenium, and rhodium, alone or in a mixture, have proven especially suitable, particular preference being given to nickel catalysts, palladium catalysts and/or ruthenium catalysts.

In order to increase the activity, selectivity and/or service life it is possible for the catalysts additionally to contain doping metals or other modifiers. Examples of typical doping metals are Mo, Fe, Ag, Cr, Ni, V, Ga, In, Bi, Ti, Zr, and Mn, and also the rare earths. Examples of typical modifiers are those which can be used to influence the acid-based properties of the catalysts, such as alkali metals and alkaline earth metals and/or compounds thereof and also phosphoric acid or sulphuric acid and compounds thereof. The catalysts can be employed in the form of powders or shaped bodies, such as extrudates or compressed powders, for example. It is possible to employ solid catalysts, Raney-type catalysts or supported catalysts. Preference is given to Raney-type and supported catalysts. Suitable support materials are, for example, kieselguhr, silica, alumina, alumosilicates, titanium dioxide, zirconium dioxide, aluminium-silicon mixed oxides, magnesium oxide, and activated carbon. The active metal can be applied to the support material in a way which is known to the skilled worker, such as by impregnation, spray application or precipitation, for example. Depending on the nature of catalyst preparation, further preparation steps, known to the skilled worker, are needed, such as drying, calcining, shaping, and activation, for example. For shaping it is possible optionally to add further auxiliaries such as graphite or magnesium stearate, for example.

The catalytic hydrogenation may take place in the melt, in solution in a suitable solvent or in the hydrogenation product itself as “solvent”. The solvent used if desired can be separated off if desired after the end of reaction. The solvent separated off can be recycled to the process, with additional purification steps for complete or partial removal of light or heavy volatile byproducts, such as methanol and water, possibly being necessary, depending on the solvent used. Suitable solvents are those in which not only the reactant but also the product dissolve in sufficient amount and which behave inertly under the selected hydrogenation conditions. These solvents are, for example, alcohols, preferably n-butanol and isobutanol, cyclic ethers, preferably tetrahydrofuran and dioxane, alkyl ethers, aromatics, such as xylene, and esters, such as ethyl acetate and butyl acetate, for example. Mixtures of these solvents are also possible. The concentration of the resin in the solvent can be varied from 1% to 99% by weight, preferably from 10% to 50% by weight.

In order to achieve high conversions with very low reactor residence times, relatively high pressures are advantageous. The overall pressure in the reactor is from 150 to 350 bar, preferably 175 to 300 bar, more preferably 200 to 300 bar. The hydrogenation temperature is dependent on the hydrogenation catalyst used. For instance, for rhodium catalysts temperatures of from just 40 to 75° C., preferably from 40 to 60° C., are sufficient, whereas palladium, ruthenium or nickel catalysts require higher temperatures. The optimum temperatures are from 150 to 250° C., preferably from 150 to 225° C.

Hydrogenation to give the resins of the invention may take place in batch or continuous mode. Also possible is a semibatch mode in which resin and/or solvent are supplied continuously to a reactor and/or one or more reaction products and/or solvents are removed continuously.

The space velocity over the catalyst is from 0.05 to 4 t of resin per cubic meter of catalyst per hour, preferably from 0.1 to 2 t of resin per cubic meter of catalyst per hour.

In order to control the temperature profile in the reactor and especially in order to limit the maximum temperature there are a variety of suitable methods known to the skilled worker. Thus, for example, in the case of sufficiently low resin concentrations, reaction may take place entirely without additional reactor cooling, the reaction medium taking up all of the energy released and conveying it out of the reactor by convection. Additionally suitable, for example, are tray reactors with intermediate cooling, the use of hydrogen circuits with gas cooling, the recycling of some of the cooled product (circulation reactor), and the use of external cooling circuits, particularly in the case of tube bundle reactors.

### Preferred Embodiment I for Preparing the Carbonyl-Hydrogenated Resins

The hydrogenation of the carbonyl-containing, aromatic resin A) prepared is accomplished preferably using catalysts based on nickel, palladium and/or ruthenium.

Particularly appropriate for preparing the resins of the invention are continuous fixed-bed reactors, such as shaft ovens and tube bundles, for example, which are operated preferably in trickle mode. In this case hydrogen and the resin for hydrogenation, if desired in solution in a solvent, are fed in at the top of the reactor onto the catalyst bed. Alternatively the hydrogen can also be passed in countercurrent from bottom to top. The reaction mixture leaving the reactor is passed through a filter in order to remove residues of catalyst. The solvent present if desired can then—if desired—be separated off.

For removing the heat of reaction released in the course of the hydrogenation, and/or for reducing the temperature rise, there are a variety of suitable methods.

This can be done, for example, by means of a gas circuit, by supplying the reactor with an amount of hydrogen greater than that necessary in accordance with the stoichiometry. The hydrogen which emerges at the end of the reactor is cooled and passed back to the top of the reactor.

In tube-bundle reactors the heat of reaction is removed preferably by way of an external coolant circuit.

Another suitable temperature-control method is the recycling of a portion of the product to the reactor inlet (circulation reactor). The reaction product can be recycled just as it is on leaving the reactor, without further working-up. Alternatively it may be advantageous to provide an additional working-up step prior to recycling—for example, the removal of part of the solvent used. The product can be recycled at the temperature at which it leaves the reactor, or else can be cooled first of all in order to remove at least some of the heat of reaction.

Combinations of the different temperature-control variants are also possible.

### Preferred Embodiment II for Preparing the Carbonyl-Hydrogenated Resins

The carbonyl-containing, aromatic resin A) prepared can also be hydrogenated batchwise in batch reactors (autoclaves). Here again, catalysts based on nickel, palladium and/or ruthenium are used with preference.

The resin for hydrogenation, in solution if desired in a solvent, is introduced into the reactor. The catalyst is added in powder form and suspended in the reaction medium by means of appropriate methods known to the skilled worker. Examples of particularly suitable reactor types include stirred-tank reactors, bubble columns, Kvaerner-Buss loop reactors, and Biazzi reactors. The overall pressure is set by adding the hydrogen. In this context it is also possible to control the progress of the reaction or the quality of the product by way of the amount of hydrogen supplied. Thus it may be advantageous, especially at the beginning of the reaction, for example, to limit the amount of hydrogen supplied, in order to prevent excessive heat being given off owing to the exothermic nature of the reaction.

In batchwise operation it is also possible not to suspend the catalyst as a powder in the reaction medium, but instead to operate with shaped bodies that are typical for fixed-bed reactors, such as extrudates, pellets or tablets. In this case it is preferable to pass the resin to be hydrogenated, where appropriate in solution in a solvent, over the fixed-bed catalyst until the desired degree of hydrogenation has been reached. The fixed-bed catalyst can be placed in a separate reaction tube, or else may be located in metal baskets or other suitable containers directly in the reactor.

Irrespective of whether powder catalysts or fixed-bed catalysts are employed, the reaction mixture leaving the reactor is passed through a filter in order to remove catalyst residues. Any solvent present can be separated off subsequently if desired.

### Analytical Methods

### Determination of Free Formaldehyde Content

The formaldehyde content is determined by post-column derivatization by the lutidine method, by means of HPLC.

### Determination of Hydroxyl Number

This is determined by a method based on DIN 53240-2 “Determination of hydroxyl number”.

It should be ensured here that an acetylation time of 3 h exactly is observed.

### Determination of Carbonyl Number

This is determined by FT-IR spectroscopy after calibration with 2-ethylhexanone in THF in an NaCl cell.

### Determining the Level of Nonhydrogenated Aromatic Structural Elements

This is determined by FT-IR spectroscopy relative to the particular alkyl aryl ketone (acetophenone, for example), in THF in an NaCl cell.

### Determining the Nonvolatiles Content (NVC)

The amount of nonvolatile fractions is reported as an average value from a duplicate determination. Approximately 2 g of sample (mass m₂ of substance) are weighed out on an analytical balance into a cleaned aluminium dish (tare mass m₁). Subsequently the aluminium dish is placed in a circulated-air heating cabinet at 150° C. for 24 h. The dish is cooled to room temperature and reweighed to a precision of 0.1 mg (m₃). The nonvolatiles content (NVC) is calculated using the following equation:

$$NVC = \frac{{m}_{3} - {m}_{1}}{{m}_{2}} \cdot 100 [ \% by weight ]$$

### Determination of Gardner Colour Number

The Gardner colour number is determined in 50% strength by weight solution of the resin in ethyl acetate in a method based on DIN ISO 4630.

The colour number is likewise determined after thermal exposure. For this purpose the resin is first stored in an air atmosphere at 150° C. for 24 h (see Determination of nonvolatiles content). After that the Gardner colour number is determined in 50% strength by weight solution of the thermally exposed resin in ethyl acetate in a method based on DIN ISO 4630.

### Determination of Solution Viscosity

To determine the solution viscosity the resin is dissolved 40% by weight in phenoxyethanol. The viscosity is measured at 20° C. using a plate/cone rotational viscometer (1/40 s).

### Determination of Polydispersity

The molecular weight distribution of the resins of the invention is measured by means of gel permeation chromatography in tetrahydrofuran against polystyrene standards.

The polydispersity (Mw/Mn) is calculated from the ratio of the weight average (Mw) to the number average (Mn).

### Determination of Melting Range

The determination is made using a capillary melting point measurement instrument (Büchi B-545) in a method based on DIN 53181.

### Determination of Amount of Crystallisable Compounds

Solutions of the hydrogenated resins in phenoxyethanol are stored for crystal formation. The crystals are separated off in dilution with ethanol, isolated on a membrane filter, and weighed.

### Determining the Solubility

Solutions of the resins in ethanol, white spirit, and n-hexane are prepared. This is done by dissolving the resins at 10% and 50% strength by weight in the respective solvent, with stirring, and assessing the clarity of the solution visually.

### Calculation of Copolymer Distribution

The procedure used for calculating the values of k, l, and m is as follows:

### Calculation Example (Whole Numbers Used for the Purpose of Illustration):

$$With R = {cyclohexyl}^{\#\#}$$

### Assumptions:

The molecular weight (Mn) is taken to be 1000 g/mol, the OH number 150 mg KOH/g, and the carbonyl number 10 mg KOH/g.

An OH number of 300 mg KOH/g results in (150/56110*1000) 2.7 OH groups per 1000 g/mol. This means that k=2.7.

A C═O number of 10 mg KOH/g results in (10/56110*1000) 0.2 C═O groups per 1000 g/mol. This means that I=0.2.

Calculation of m: (1000 g/mol−(5.35 mol*139 g/mol)−(0.18 mol*137 g/mol))/123 g/mol=4.9

The sum of k+m+l is therefore 7.8.

The examples which follow are intended to illustrate the invention but not to restrict its scope of application.

### EXAMPLES

### Noninventive, Comparative Examples

The document that best describes the prior art is DE 33 34 631 A1.

The acetophenone/formaldehyde resin used here was obtained in accordance with Example 2 of DE 892 975.

### Example A

### Reworking of Example 2 of DE 892 975

1200 g of acetophenone are admixed with 240 g of 50% strength by weight aqueous potassium hydroxide solution and 400 g of methanol and then, over the course of 2 h and with vigorous stirring, with 1000 g of 30% strength by weight formaldehyde solution. In the course of this addition the temperature rises to 90° C. This temperature is held for 10 h. The batch is acidified with sulphuric acid and the condensation product formed is washed with hot water, melted, and dewatered under reduced pressure.

This gives 1260 g of a yellow resin. The resin is clear and brittle and possesses a melting point of 67° C. The Gardner colour number is 3.8 (50% strength by weight in ethyl acetate). It is soluble for example in acetates such as butyl acetate and ethyl acetate and in aromatics such as toluene and xylene. It is insoluble in ethanol. The formaldehyde content is 255 ppm.

### Example B

### Reworking of Example 3 of DE 33 34 631 A1

The resin from Example A was dissolved at 30% strength by weight in isobutanol with heating. Hydrogenation was carried out in a continuously operated fixed-bed reactor which was filled with 400 ml of a commercially customary nickel catalyst (Engelhard Ni 5126T1/8). This catalyst, according to information from Engelhard, is identical with the catalyst “Harshaw Ni 5124” used in DE 33 34 631. At 300 bar and 180° C., 250 ml of the reaction mixture are passed hourly from top to bottom through the reactor (trickle mode). The pressure is held constant by supplementary supply of hydrogen.

### Example C

### Reworking of Example 4 of DE 33 34 631 A1

300 g of the resin from Example A were dissolved in 700 g of isobutanol with heating. Hydrogenation then took place at 300 bar and 200° C. in an autoclave (from Parr) with catalyst basket filled with 90 g of a commercially customary Pd catalyst (0.5% by weight Pd on Al₂O₃). After 4 h the reaction mixture was discharged from the reactor via a filter.

### Inventive Examples

### Inventive Example I

### Preparation of a Base Resin for Further Hydrogenation, Based on Acetophenone and Formaldehyde

1200 g of acetophenone, 220 g of methanol, 0.3 g of benzyltributylammonium chloride, and 360 g of a 30% strength by weight aqueous formaldehyde solution are charged to a reactor and homogenised with stirring. Then 32 g of 25% strength by weight aqueous sodium hydroxide solution are added with stirring. At 80 to 85° C. 655 g of a 30% strength by weight aqueous formaldehyde solution are added with stirring over the course of 90 minutes. After 5 h of stirring at reflux temperature, the stirrer is switched off and the aqueous phase is separated from the resin phase. The crude product is washed with water to which acetic acid has been added, washing taking place until a melt sample of the resin appears clear. The resin is then dried by distillation.

This gives 1270 g of a pale yellowish resin. The resin is clear and brittle and possesses a melting point of 72° C. The Gardner colour number is 0.8 (50% strength by weight in ethyl acetate). It is soluble for example in acetates such as butyl acetate and ethyl acetate and in aromatics such as toluene and xylene. It is insoluble in ethanol. The formaldehyde content is 35 ppm.

Hydrogenation of the Resin Based on Cyclohexanone and Formaldehyde from Example I)

### Inventive Example 1

The resin from Example I) was dissolved 30% by weight in isobutanol, with heating. The hydrogenation took place in a continuously operated fixed bed reactor packed with 400 ml of a commercially customary Raney-Nickel fixed-bed catalyst. At 275 bar and 180° C. 240 ml/h of the reaction mixture were passed through the reactor from top to bottom (trickle mode). The pressure is held constant by introducing further hydrogen.

### Inventive Example 2

The resin from Example I) was dissolved 30% by weight in isobutanol, with heating. The hydrogenation took place in a continuously operated fixed bed reactor packed with 400 ml of a commercially customary Raney-Nickel fixed-bed catalyst. At 275 bar and 170° C. 400 ml/h of the reaction mixture were passed through the reactor from top to bottom (trickle mode). The pressure is held constant by introducing further hydrogen.

### Inventive Example 3

300 g of the resin from Example I) were dissolved with heating in 700 g of isobutanol. The hydrogenation then took place at 260 bar and 160° C. in an autoclave (Parr) with a catalyst basket filled with 100 ml of a commercial customary nickel catalyst (Engelhard Ni 5126T1/8). After 5 h the reaction mixture was discharged from the reactor via a filter.

### Inventive Example 4

300 g of the resin from Example I) were dissolved with heating in 700 g of isobutanol. The hydrogenation then took place at 260 bar and 180° C. in an autoclave (Parr) with a catalyst basket filled with 100 ml of a commercially customary Raney nickel fixed-bed catalyst. After 4 h the reaction mixture was discharged from the reactor via a filter.

The resin solutions from inventive Examples 1 to 4 and comparative Examples B and C are freed from the solvent under reduced pressure. The properties of the resultant resins are listed in Table 1.

TABLE 1
Properties of the hydrogenated resins of the Examples 1 to 4 and
Comparative Examples B and C

| | Comp. Ex. | Comp. Ex. | Resin | Resin | Resin | Resin |
|---|---|---|---|---|---|---|
| | B | C | 1 | 2 | 3 | 4 |
| Free formaldehyde content [ppm] | 5.2 | 5.8 | 1.2 | 1.4 | 1.1 | 0.9 |
| Amount of crystallisable | 3.3 | 3.2 | <0.1 | <0.1 | <0.1 | <0.1 |
| compounds [% by weight] | | | | | | |
| Carbonyl number [mg KOH/g] | 21.4 | 24.3 | 4.8 | 9.9 | 7.1 | 9.0 |
| Hydroxyl number [mg KOH/g] | 205 | 202 | 76 | 145 | 101 | 161 |
| Aromatics fraction [mg | 11.7 | 14.9 | 2.6 | 4.5 | 4.9 | 3.0 |
| acetophenone/g] | | | | | | |
| Melting point [° C.] | 83 | 89 | 85 | 95 | 79 | 88 |
| Nonvolatiles content | 98.8 | 99.1 | 99.4 | 99.6 | 98.7 | 99.1 |
| (24 h at 150° C.) [% by weight] | | | | | | |
| Gardner colour number (50% by | 1.4 | 1.6 | 0.0 | 0.0 | 0.0 | 0.0 |
| weight in ethyl acetate) | | | | | | |
| Gardner colour number | 2.4 | 2.3 | 0.2 | 0.3 | 0.4 | 0.3 |
| (after thermal exposure for 24 h at | | | | | | |
| 150° C.; 50% by weight in ethyl | | | | | | |
| acetate) | | | | | | |
| Viscosity (40% by weight in | 9400 | 9200 | 5100 | 6700 | 5750 | 7100 |
| phenoxyethanol) | | | | | | |
| Mn (GPC against PS) [g · mol⁻¹] | 940 | 930 | 890 | 900 | 910 | 900 |
| Mw (GPC against PS) [g · mol⁻¹] | 1650 | 1650 | 1350 | 1320 | 1410 | 1370 |
| Polydispersity | 1.76 | 1.77 | 1.52 | 1.47 | 1.55 | 1.52 |
| k | 3.4 | 3.3 | 1.21 | 2.33 | 1.64 | 2.58 |
| l | 0.4 | 0.4 | 0.08 | 0.16 | 0.11 | 0.14 |
| m | 3.4 | 3.3 | 5.79 | 4.51 | 5.42 | 4.24 |
| k + l + m | 7.2 | 7.1 | 7.07 | 7.00 | 7.17 | 6.96 |
| m/k | 1.0 | 1.0 | 4.8 | 1.94 | 3.31 | 1.64 |
| Solubility | | | | | | |
| (10%/50% by weight) | | | | | | |
| ethanol | slightly | slightly | clear/ | clear/ | clear/ | clear/ |
| | turbid/clear | turbid/clear | clear | clear | clear | clear |
| white spirit | clear/ | clear/ | clear/ | clear/ | clear/ | clear/ |
| | clear | clear | clear | clear | clear | clear |
| n-hexane | milky/clear | turbid/slightly | clear/ | clear/ | clear/ | clear/ |
| | | turbid | clear | clear | clear | clear |

All of the resins obtained are light-coloured, clear, and brittle.

In comparison to the non-inventive resins of Examples B and C, resins 1 to 4 of the invention have a much lower free formaldehyde content and a much lower level of crystallisable compounds. In accordance with the lower carbonyl number, the colour numbers both before and after thermal exposure are lower. The solution viscosities of resins 1 to 4 of the invention are located at a significantly lower level as compared with those of the non-inventive resins of Examples B and C. This may be explained where appropriate by the higher polydispersity of the non-inventive resins.

The resins of Inventive Examples 1 to 4 are flawlessly soluble at 10% and 50% strength by weight in ethanol, in white spirit, and in n-hexane. Contrastingly, the resins from Comparative Examples B and C are no longer flawlessly soluble in ethanol and in n-hexane at concentrations of 10% by weight solids fraction. This may possibly be attributable to the higher proportions of aromatics and to the low m/k ratio (in both cases about 1.0).

Since not all of the properties obtained in the resins of the invention are causally attributable to the hydrogenating conditions, the process by which the initial resin is prepared evidently has a substantial influence over the properties of the hydrogenated resins obtained.

1: An OH-functional, carbonyl- and ring-hydrogenated ketone-aldehyde resin based on alkyl aryl ketones and formaldehyde, having a hydroxyl number of at least 75 mg KOH/g, having a free formaldehyde content of less than 3 ppm, and containing substantially the structural elements of formula II 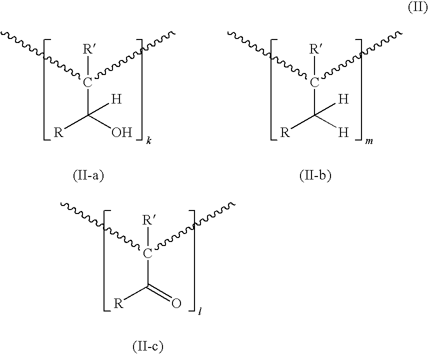
where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),
R′ is H, CH₂OH,
k is 1 to 10,
m is 2 to 12,
l is 0 to 0.35,
the sum of k+l+m being from 3 to 24,
the ratio of m/k is >1.0,
and the three structural elements possibly being distributed alternately or randomly, and the structural elements being linked linearly via CH₂ groups and/or with branching via CH groups.

2: An OH-functional, carbonyl- and ring-hydrogenated ketone-aldehyde resin based on alkyl aryl ketones and formaldehyde, having a hydroxyl number of at least 75 mg KOH/g, having a free formaldehyde content of less than 3 ppm, and containing substantially the structural elements of formula II 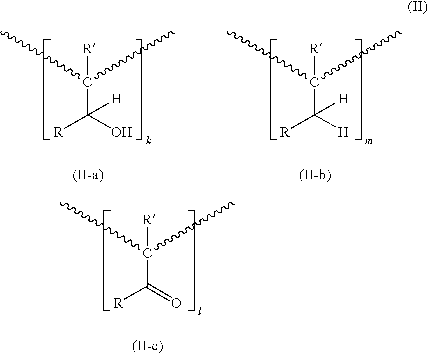
where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),
R′ is H, CH₂OH,
k is 1 to 10,
m is 2 to 12,
l is 0 to 0.35,
the sum of k+l+m being from 3 to 24,
the ratio m/l is >1.0
and the three structural elements possibly being distributed alternately or randomly, and the structural elements being linked linearly via CH₂ groups and/or or with branching via CH groups,
obtained by
A) preparing the base resin by condensing at least one ketone with at least one aldehyde in the presence of at least one basic catalyst and, if desired, of at least one phase transfer catalyst, solventlessly or using a water-miscible organic solvent,
and subsequently
B) subjecting the carbonyl groups and the aromatic groups of the ketone-aldehyde resin (A) to continuous, semibatchwise or batchwise hydrogenation in the melt or in solution in a suitable solvent with hydrogen in the presence of a catalyst at pressures from 150 to 350 bar and at temperatures from 150 to 250° C.

3: A carbonyl- and ring-hydrogenated ketone-aldehyde resin based on alkyl aryl ketones and formaldehyde according to claim 1,
characterized in that
the free formaldehyde content is below 3 ppm, preferably below 2.5 ppm, more preferably below 2.0 ppm.

4: A carbonyl- and ring-hydrogenated ketone-aldehyde resin based on alkyl aryl ketones and formaldehyde according to claim 1,
characterized in that
the amount of crystallisable compounds is below 3%, preferably below 2%, more preferably below 1% by weight.

5: A carbonyl- and ring-hydrogenated ketone-aldehyde resin based on alkyl aryl ketones and formaldehyde according to claim 1,
characterized in that
the carbonyl number is from 0 to 20 mg KOH/g, preferably from 0 to 18 mg KOH/g, more preferably from 0 to 15 mg KOH/g.

6: A carbonyl- and ring-hydrogenated ketone-aldehyde resin based on alkyl aryl ketones and formaldehyde according to claim 1,
characterized in that
the hydroxyl number is from 75 to 350 mg KOH/g, preferably from 75 to 200 mg KOH/g, more preferably from 75 to 180 mg KOH/g.

7: A carbonyl- and ring-hydrogenated ketone-aldehyde resin based on alkyl aryl ketones and formaldehyde according to claim 1,
characterized in that
the proportion of aromatic structural elements is below 10, preferably below 5 mg alkyl aryl ketone/g (based on alkyl aryl ketone).

8: A carbonyl- and ring-hydrogenated ketone-aldehyde resin based on alkyl aryl ketones and formaldehyde according to claim 1,
characterized in that
the Gardner colour number (50% by weight of ethyl acetate) is below 1.5, preferably below 1.0, more preferably below 0.75.

9: A carbonyl- and ring-hydrogenated ketone-aldehyde resin based on alkyl aryl ketones and formaldehyde according to claim 1,
characterized in that
the Gardner colour number (50% by weight of ethyl acetate) after thermal exposure of the resin (24 h, 150° C.) is below 2.0, preferably below 1.5, more preferably below 1.0.

10: A carbonyl- and ring-hydrogenated ketone-aldehyde resin based on alkyl aryl ketones and formaldehyde according to claim 1,
characterized in that
the polydispersity (Mw/Mn) of the resin is from 1.35 to 1.7, more preferably from 1.4 to 1.6.

11: A carbonyl- and ring-hydrogenated ketone-aldehyde resin based on alkyl aryl ketones and formaldehyde according to claim 1,
characterized in that
the solution viscosity, 40% strength by weight in Isopar H, is from 1000 to 15 000 mPa·s, more preferably from 3000 to 10 000 mPa·s.

12: A carbonyl- and ring-hydrogenated ketone-aldehyde resin based on alkyl aryl ketones and formaldehyde according to claim 1,
characterized in that
the melting point/range is from 50 to 150° C., preferably from 60 to 140° C., more preferably from 75 to 130° C.

13: A carbonyl- and ring-hydrogenated ketone-aldehyde resin based on alkyl aryl ketones and formaldehyde according to claim 1
characterized in that
the amount of nonvolatile constituents after heating at 150° C. for 24 h is more than 97.%, preferably more than 97.5% by weight.

14: A carbonyl- and ring-hydrogenated ketone-aldehyde resin based on alkyl aryl ketones and formaldehyde according to claim 1,
characterized in that
it is soluble in n-hexane, white spirit, and ethanol at 10% and 50% strength by weight.

15: A carbonyl- and ring-hydrogenated ketone-aldehyde resin based on alkyl aryl ketones and formaldehyde according to claim 1,
characterized in that
aromatic α-methyl ketones are present.

16: A carbonyl- and ring-hydrogenated ketone-aldehyde resin based on alkyl aryl ketones and formaldehyde according to claim 1,
characterized in that
acetophenone, acetophenone derivatives such as hydroxyacetophenone, for example, alkyl-substituted acetophenone derivatives having 1 to 8 carbon atoms on the phenyl ring, methoxyacetophenone, alone or in mixtures, are present.

17: A carbonyl- and ring-hydrogenated ketone-aldehyde resin based on alkyl aryl ketones and formaldehyde according to claim 1,
characterized in that
further CH-acidic ketones are used in a mixture with the alkylaromatic ketones in a proportion of up to 30 mol %, preferably up to 15 mol %, based on the ketone component, and are selected from acetone, methyl ethyl ketone, 3,3-dimethylbutanone, methyl isobutyl ketone, propiophenone, heptan-2-one, pentan-3-one, cyclopentanone, cyclododecanone, mixtures of 2,2,4- and 2,4,4-trimethylcyclopentanone, cycloheptanone, cyclooctanone, cyclohexanone and all alkyl-substituted cyclohexanones having one or more alkyl radicals with a total of 1 to 8 carbon atoms, individually or in a mixture.

18: A carbonyl- and ring-hydrogenated ketone-aldehyde resin based on alkyl aryl ketones and formaldehyde according to claim 1,
characterized in that
alkyl-substituted cyclohexanones present are 4-tert-amylcyclohexanone, 2-sec-butyl-cyclohexanone, 2-tert-butylcyclohexanone, 4-tert-butylcyclohexanone, 2-methylcyclohexanone and/or 3,3,5-trimethylcyclohexanone.

19: A carbonyl- and ring-hydrogenated ketone-aldehyde resin based on alkyl aryl ketones and formaldehyde according to claim 1, characterized in that
formaldehyde and/or formaldehyde donor compounds are used as starting compounds for preparing the ketone-aldehyde resin.

20: A carbonyl- and ring-hydrogenated ketone-aldehyde resin based on alkyl aryl ketones and formaldehyde according to claim 1, characterized in that
formaldehyde and/or para-formaldehyde and/or trioxane are used as starting compounds for preparing the ketone-aldehyde resin.

21: A carbonyl- and ring-hydrogenated ketone-aldehyde resin based on alkyl aryl ketones and formaldehyde according to claim 1, characterized in that,
further to formaldehyde and/or formaldehyde donor compounds, aldehydes selected from acetaldehyde, n-butyraldehyde, isobutyraldehyde, valeraldehyde, dodecanal, alone or in mixtures in fractions from 0 to 75 mol %, preferably from 0 to 50 mol %, more preferably from 0 to 25 mol %, based on the aldehyde component, are used as starting compounds for preparing the ketone-aldehyde resin.

22: A carbonyl- and ring-hydrogenated ketone-aldehyde resin based on alkyl aryl ketones and formaldehyde according to claim 1,
characterized in that
acetophenone and, if desired, CH-acidic ketones selected from cyclohexanone, methyl ethyl ketone, 2-tert-butylcyclohexanone, 4-tert-butylcyclohexanone, and 3,3,5-trimethylcyclohexanone, alone or in mixtures, and formaldehyde are used as starting compounds for preparing the ketone-aldehyde resin.

23: A carbonyl- and ring-hydrogenated ketone-aldehyde resin based on alkyl aryl ketones and formaldehyde according to claim 1, characterized in that
the molar ratio of the ketone to the aldehyde component is from 1:0.25 to 1:15, preferably from 1:0.9 to 1:5, and more preferably from 1:0.95 to 1:4.

24: A process for preparing an OH-functional, carbonyl- and ring-hydrogenated ketone-aldehyde resin based on alkyl aryl ketones and formaldehyde, having a hydroxyl number of at least 75 mg KOH/g and having a free formaldehyde content of less than 3 ppm, which substantially contains the structural elements of formula II, characterized by
A) preparation of the base resin by condensing at least one ketone with at least one aldehyde in the presence of at least one basic catalyst and, if desired, of at least one phase transfer catalyst, solventlessly or using a water-miscible organic solvent,
and subsequently
B) the subjecting of the carbonyl groups and the aromatic groups of the ketone-aldehyde resin (A) to continuous, semibatchwise or batchwise hydrogenation in the melt or in solution in a suitable solvent with hydrogen in the presence of a catalyst at pressures from 150 to 350 bar and at temperatures from 150 to 250° C.

25: A process according to claim 24,
characterized in that reaction A) is carried out in a basic medium.

26: A process according to claim 25,
characterized in that hydroxides of the cations NH₄, NR₄, with R═H, alkyl and/or benzyl, Li or Na, preferably hydroxides of the cations NH₄, NR₄, with R═H, alkyl and/or benzyl, Li or Na, are used as basic catalysts for preparing the carbonyl-containing ketone-aldehyde resins with R═H, alkyl and/or benzyl.

27: A process according to claim 24, characterized in that the carbonyl-group-containing ketone-aldehyde resin with R═H, alkyl and/or benzyl, is prepared using auxiliary solvent.

28: A process according to claim 27, characterized in that the carbonyl-containing ketone-aldehyde resin with R═H, alkyl and/or benzyl, is prepared using auxiliary solvent selected from water-miscible alcohols and/or ketones.

29: A process according to claim 24, characterized in that
additionally, a phase transfer catalyst is used in amounts from 0.01% to 15%, preferably from 0.1% to 10.0%, and in particular in amounts from 0.1% to 5.0%, by weight based on the ketone employed, in order to produce the carbonyl-containing ketone aldehyde resin A).

30: A process according to claim 29,
characterized in that
cetyldimethylbenzylammonium chloride, benzyltributylammonium chloride and/or triethylbenzylammonium chloride are used as quaternary ammonium salts and triphenylbenzylphosphonium chloride and/or triphenylbenzylphosphonium iodide are used as quaternary phosphonium salts.

31: A process according to claim 24,
characterized in that
the base resin A) is purified by washing with water using acids.

32: A process according to claim 31,
characterized in that
the base resin A) is purified by washing with water using organic acids having 1 to 6, preferably 1 to 4 carbon atoms.

33: A process according to claim 24,
characterized in that
a homogeneous or heterogeneous catalyst is used for hydrogenating the carbonyl-containing base resin A).

34: A process according to claim 24,
characterized in that
metal catalysts are used for the hydrogenation.

35: A process according to claim 24,
characterized in that
metal catalysts are used for the hydrogenation that contain the metals nickel, copper, copper-chromium, palladium, platinum, ruthenium, and rhodium, alone or in mixtures, preferably nickel, palladium, and ruthenium, alone or in a mixture, as principal metals.

36: A process according to claim 24,
characterized in that
the metal catalysts further contain doping metals and/or other modifiers.

37: A process according to claim 36,
characterized in that
additional doping metals are present, selected from Mo, Fe, Ag, Cr, Ni, V, Ga, In, Bi, Ti, Zr, and Mn, and also from the rare earths.

38: A process according to claim 24,
characterized in that
modifiers are present selected from alkali metals and alkaline earth metals and/or compounds thereof, and/or phosphoric acid and/or sulphuric acid and also compounds thereof.

39: A process according to claim 24,
characterized in that
the catalysts are used in the form of powders or shaped bodies.

40: A process according to claim 24,
characterized in that
the catalysts are used in the form of solid catalysts, Raney-type catalysts or supported catalysts.

41: A process according to claim 40,
characterized in that
kieselguhr, silica, alumina, aluminosilicates, titanium dioxide, zirconium dioxide, aluminium-silicon mixed oxides, magnesium oxide and/or activated carbon are used as support material.

42: A process according to claim 24,
characterized in that
the catalytic hydrogenation is carried out in the melt, in solution in a suitable solvent or in the hydrogenation product itself as “solvent”.

43: A process according to claim 42,
characterized in that
n-butanol, isobutanol, tetrahydrofuran, ethyl acetate, butyl acetate, xylene, dioxane, diethyl ether and/or diethylene glycol are used as solvents.

44: A process according to claim 42,
characterized in that
the solvent present if desired is separated off after the end of reaction and recycled to the circuit.

45: A process according to claim 24,
characterized in that
an OH-functional, carbonyl- and ring-hydrogenated ketone-aldehyde resin based on alkyl aryl ketones and formaldehyde, having a hydroxyl number of at least 75 mg KOH/g, having a free formaldehyde content of less than 3 ppm, and containing substantially the structural elements of formula II 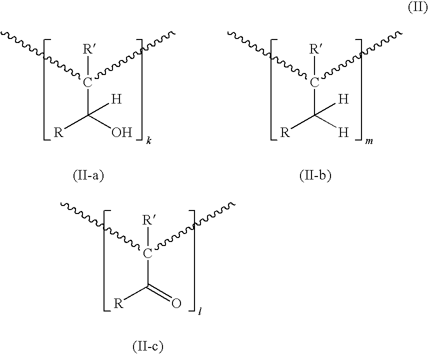
where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),
R′ is H, CH₂OH,
k is 1 to 10,
m is 2 to 12,
l is 0 to 0.35,
the sum of k+l+m being from 3 to 24,
the ratio of m/k is >1.0,
and the three structural elements possibly being distributed alternately or randomly, and the structural elements being linked linearly via CH₂ groups and/or with branching via CH groups are used.

46: A process according to claim 24,
characterized in that
the space velocity over the catalyst is from 0.05 to 4 t of resin per cubic meter of catalyst per hour, preferably from 0.1 to 2 t of resin per cubic meter of catalyst per hour.

47: A process according to claim 24,
characterized in that
the hydrogenation takes place batchwise, continuously or semibatchwise.

48: A process according to claim 24,
characterized in that
the hydrogenation takes place continuously.

49: A process according to claim 24,
characterized in that
hydrogenation takes place in a fixed bed reactor.

50: A process according to claim 24,
characterized in that
hydrogenation takes place in shaft ovens or tube bundles.

51: A process according to claim 24,
characterized in that
hydrogenation takes place in trickle mode.

52: A process according to claim 24,
characterized in that
hydrogen and the resin for hydrogenation, if desired in solution in a solvent, is fed in at the top of the reactor onto the catalyst bed.

53: A process according to claim 24,
characterized in that
the hydrogen is passed in countercurrent from bottom to top.

54: A process according to claim 24,
characterized in that
hydrogenation takes place discontinuously.

55: A process according to claim 24,
characterized in that
hydrogenation takes place in batch reactors (autoclaves).

56: A process according to claim 24,
characterized in that
hydrogenation takes place in stirred-tank reactors, bubble columns, Kvaerner-Buss loop reactors or Biazzi reactors.

57: A process according to claim 24,
characterized in that
first of all the carbonyl-containing base resin A) is prepared, by
introducing and homogenizing 10 mol (or a multiple) of a ketone or a mixture of different ketones according to the claims in a 50% to 90% strength methanolic solution, 0 to 5% by weight of a phase transfer catalyst, and 1 to 5 mol (or a multiple) of an aqueous formaldehyde solution, with stirring,
adding from 0.1 to 5 mol (or a multiple) of an aqueous sodium hydroxide solution with stirring,
adding from 4 to 10 mol (or a multiple) of an aqueous formaldehyde solution at 70 to 115° C. with stirring over 30 to 120 min,
switching off the stirrer after a further 0.5 to 5 h of stirring at reflux temperature, it being optionally possible, after about a third of the operating time, to add a further 0.1 to 1 mol (or a multiple) of an aqueous formaldehyde solution,
separating the aqueous phase from the resin phase,
washing the crude product with water, using an organic acid, until a melt sample of the resin appears clear,
and
finally drying the resin by distillation.

58: A carbonyl- and ring-hydrogenated ketone-aldehyde resin based on alkyl aryl ketones and formaldehyde according to claim 2,
characterized in that
the free formaldehyde content is below 3 ppm, preferably below 2.5 ppm, more preferably below 2.0 ppm.

59: A carbonyl- and ring-hydrogenated ketone-aldehyde resin based on alkyl aryl ketones and formaldehyde according to claim 2,
characterized in that
the amount of crystallisable compounds is below 3%, preferably below 2%, more preferably below 1% by weight.

60: A carbonyl- and ring-hydrogenated ketone-aldehyde resin based on alkyl aryl ketones and formaldehyde according to claim 2,
characterized in that
the carbonyl number is from 0 to 20 mg KOH/g, preferably from 0 to 18 mg KOH/g, more preferably from 0 to 15 mg KOH/g.

61: A carbonyl- and ring-hydrogenated ketone-aldehyde resin based on alkyl aryl ketones and formaldehyde according to claim 2,
characterized in that
the hydroxyl number is from 75 to 350 mg KOH/g, preferably from 75 to 200 mg KOH/g, more preferably from 75 to 180 mg KOH/g.

62: A carbonyl- and ring-hydrogenated ketone-aldehyde resin based on alkyl aryl ketones and formaldehyde according to claim 2,
characterized in that
the proportion of aromatic structural elements is below 10, preferably below 5 mg alkyl aryl ketone/g (based on alkyl aryl ketone).

63: A carbonyl- and ring-hydrogenated ketone-aldehyde resin based on alkyl aryl ketones and formaldehyde according to claim 2,
characterized in that
the Gardner colour number (50% by weight of ethyl acetate) is below 1.5, preferably below 1.0, more preferably below 0.75.

64: A carbonyl- and ring-hydrogenated ketone-aldehyde resin based on alkyl aryl ketones and formaldehyde according to claim 2,
characterized in that
the Gardner colour number (50% by weight of ethyl acetate) after thermal exposure of the resin (24 h, 150° C.) is below 2.0, preferably below 1.5, more preferably below 1.0.

65: A carbonyl- and ring-hydrogenated ketone-aldehyde resin based on alkyl aryl ketones and formaldehyde according to claim 2,
characterized in that
the polydispersity (Mw/Mn) of the resin is from 1.35 to 1.7, more preferably from 1.4 to 1.6.

66: A carbonyl- and ring-hydrogenated ketone-aldehyde resin based on alkyl aryl ketones and formaldehyde according to claim 2,
characterized in that
the solution viscosity, 40% strength by weight in Isopar H, is from 1000 to 15 000 mPa·s, more preferably from 3000 to 10 000 mPa·s.

67: A carbonyl- and ring-hydrogenated ketone-aldehyde resin based on alkyl aryl ketones and formaldehyde according to claim 2,
characterized in that
the melting point/range is from 50 to 150° C., preferably from 60 to 140° C., more preferably from 75 to 130° C.

68: A carbonyl- and ring-hydrogenated ketone-aldehyde resin based on alkyl aryl ketones and formaldehyde according to claim 2,
characterized in that
the amount of nonvolatile constituents after heating at 150° C. for 24 h is more than 97.%, preferably more than 97.5% by weight.

69: A carbonyl- and ring-hydrogenated ketone-aldehyde resin based on alkyl aryl ketones and formaldehyde according to claim 2,
characterized in that
it is soluble in n-hexane, white spirit, and ethanol at 10% and 50% strength by weight.

70: A carbonyl- and ring-hydrogenated ketone-aldehyde resin based on alkyl aryl ketones and formaldehyde according to claim 2,
characterized in that
aromatic α-methyl ketones are present.

71: A carbonyl- and ring-hydrogenated ketone-aldehyde resin based on alkyl aryl ketones and formaldehyde according to claim 2,
characterized in that
acetophenone, acetophenone derivatives such as hydroxyacetophenone, for example, alkyl-substituted acetophenone derivatives having 1 to 8 carbon atoms on the phenyl ring, methoxyacetophenone, alone or in mixtures, are present.

72: A carbonyl- and ring-hydrogenated ketone-aldehyde resin based on alkyl aryl ketones and formaldehyde according to claim 2,
characterized in that
further CH-acidic ketones are used in a mixture with the alkylaromatic ketones in a proportion of up to 30 mol %, preferably up to 15 mol %, based on the ketone component, and are selected from acetone, methyl ethyl ketone, 3,3-dimethylbutanone, methyl isobutyl ketone, propiophenone, heptan-2-one, pentan-3-one, cyclopentanone, cyclododecanone, mixtures of 2,2,4- and 2,4,4-trimethylcyclopentanone, cycloheptanone, cyclooctanone, cyclohexanone and all alkyl-substituted cyclohexanones having one or more alkyl radicals with a total of 1 to 8 carbon atoms, individually or in a mixture.

73: A carbonyl- and ring-hydrogenated ketone-aldehyde resin based on alkyl aryl ketones and formaldehyde according to claim 2,
characterized in that
alkyl-substituted cyclohexanones present are 4-tert-amylcyclohexanone, 2-sec-butyl-cyclohexanone, 2-tert-butylcyclohexanone, 4-tert-butylcyclohexanone, 2-methylcyclohexanone and/or 3,3,5-trimethylcyclohexanone.

74: A carbonyl- and ring-hydrogenated ketone-aldehyde resin based on alkyl aryl ketones and formaldehyde according to claim 2, characterized in that
formaldehyde and/or formaldehyde donor compounds are used as starting compounds for preparing the ketone-aldehyde resin.

75: A carbonyl- and ring-hydrogenated ketone-aldehyde resin based on alkyl aryl ketones and formaldehyde according to claim 2, characterized in that
formaldehyde and/or para-formaldehyde and/or trioxane are used as starting compounds for preparing the ketone-aldehyde resin.

76: A carbonyl- and ring-hydrogenated ketone-aldehyde resin based on alkyl aryl ketones and formaldehyde according to claim 2, characterized in that,
further to formaldehyde and/or formaldehyde donor compounds, aldehydes selected from acetaldehyde, n-butyraldehyde, isobutyraldehyde, valeraldehyde, dodecanal, alone or in mixtures in fractions from 0 to 75 mol %, preferably from 0 to 50 mol %, more preferably from 0 to 25 mol %, based on the aldehyde component, are used as starting compounds for preparing the ketone-aldehyde resin.

77: A carbonyl- and ring-hydrogenated ketone-aldehyde resin based on alkyl aryl ketones and formaldehyde according to claim 2,
characterized in that
acetophenone and, if desired, CH-acidic ketones selected from cyclohexanone, methyl ethyl ketone, 2-tert-butylcyclohexanone, 4-tert-butylcyclohexanone, and 3,3,5-trimethylcyclohexanone, alone or in mixtures, and formaldehyde are used as starting compounds for preparing the ketone-aldehyde resin.

78: A carbonyl- and ring-hydrogenated ketone-aldehyde resin based on alkyl aryl ketones and formaldehyde according to claim 2, characterized in that
the molar ratio of the ketone to the aldehyde component is from 1:0.25 to 1:15, preferably from 1:0.9 to 1:5, and more preferably from 1:0.95 to 1:4.

79: A process according to claim 24,
characterized in that
An OH-functional, carbonyl- and ring-hydrogenated ketone-aldehyde resin based on alkyl aryl ketones and formaldehyde, having a hydroxyl number of at least 75 mg KOH/g, having a free formaldehyde content of less than 3 ppm, and containing substantially the structural elements of formula II 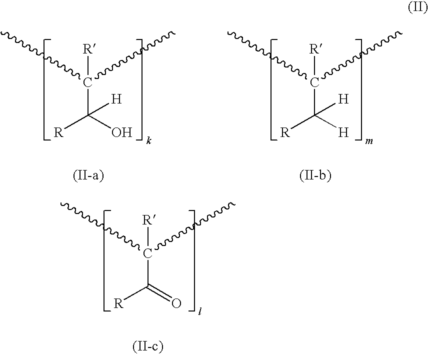
where
R is aromatic with 6 to 14 carbon atoms, cycloaliphatic with 6 to 14 carbon atoms, the proportion of the aromatic structural elements being below 10, preferably below 5 mg alkyl aryl ketone/g (based on alkyl aryl ketone),
R′ is H, CH₂OH,
k is 1 to 10,
m is 2 to 12,
l is 0 to 0.35,
the sum of k+l+m being from 3 to 24,
the ratio m/l is >1.0
and the three structural elements possibly being distributed alternately or randomly, and the structural elements being linked linearly via CH₂ groups and/or or with branching via CH groups,
obtained by
A) preparing the base resin by condensing at least one ketone with at least one aldehyde in the presence of at least one basic catalyst and, if desired, of at least one phase transfer catalyst, solventlessly or using a water-miscible organic solvent,
and subsequently
B) subjecting the carbonyl groups and the aromatic groups of the ketone-aldehyde resin (A) to continuous, semibatchwise or batchwise hydrogenation in the melt or in solution in a suitable solvent with hydrogen in the presence of a catalyst at pressures from 150 to 350 bar and at temperatures from 150 to 250° C. is used.
